(19) United States
(12) Patent Application Publication
(10) Pub. No.: US 2025/0388740 A1
(43) Pub. Date: Dec. 25, 2025

(54) TWO-DIMENSIONAL PARTICLE-CONTAINING COMPOSITION AND PRODUCTION METHOD FOR TWO-DIMENSIONAL PARTICLE-CONTAINING COMPOSITION

(71) Applicant: Murata Manufacturing Co., Ltd., Nagaokakyo-shi (JP)

(72) Inventors: Yuusuke OGAWA, Nagaokakyo-shi (JP); Masashi KOYANAGI, Nagaokakyo-shi (JP)

(21) Appl. No.: 19/311,519

(22) Filed: Aug. 27, 2025

Related U.S. Application Data
(63) Continuation of application No. PCT/JP2024/008816, filed on Mar. 7, 2024.

(30) Foreign Application Priority Data
Mar. 8, 2023 (JP) 2023-035502

(51) Int. Cl. C08K 7/00

(52) U.S. Cl. CPC C08K 7/00

(57) ABSTRACT

A two-dimensional particle-containing composition that includes two-dimensional particles of a layered material having one or plural layers; and a dispersion medium having a relative permittivity greater than that of water. The one or plural layers comprise a layer body represented by: MₘXₙ, wherein M is (1) at least one metal element M₁ of Group 3, 4, 5, 6, or 7 having a higher ionization energy than Ti, or (2) a combination of the metal element M₁ that accounts for 50 atom % or more of M and a metal element M₂ of Group 3, 4, 5, 6, or 7 other than the metal element M₁ that accounts for 50 atom % or less of M, and the two-dimensional particles have a fluorine element and an oxygen element.

### CROSS REFERENCE TO RELATED APPLICATIONS

The present application is a continuation of International application No. PCT/JP2024/008816, filed on Mar. 7, 2024, which claims priority to Japanese Patent Application No. 2023-035502, filed on Mar. 8, 2023, the entire contents of each of which are incorporated herein by reference.

### TECHNICAL FIELD

The present disclosure relates to a two-dimensional particle-containing composition and a production method for a two-dimensional particle-containing composition.

### BACKGROUND ART

In recent years, MXene has been attracting attention as a new material. MXene is a type of so-called two-dimensional material, and as will be described later, is a layered material in the form of one or plural layers. In general, MXene is in the form of particles (which can include powders, flakes, nanosheets, and the like) of such a layered material.

Currently, various studies are being conducted toward the application of MXene to various fields. For example, its application to uses that require maintaining a high electrical conductivity such as electrodes in electrical devices and electromagnetic shields (EMI shields) has been studied. As a part of the study, for example, Non-patent Document 1 shows a result of systematically studying EMI shielding characteristics of 16 types of MXenes. In particular, it is shown that EMI shielding characteristics can be controlled by changing the element ratio of solid-solution MXene.
Non-patent Document 1: Beyond Ti3C2Tx: MXenes for Electromagnetic Interference Shielding, ACS Nano 2020, 14, 4, 5008-5016

### SUMMARY OF THE DISCLOSURE

Depending on the application, a film containing MXene and having sufficiently high oxidation resistance may be required, and the film may be formed using a MXene-containing composition such as a dispersion containing MXene. However, with the technique disclosed in Non-patent Document 1, it is difficult to obtain a dispersion in which MXene is well dispersed, and as a result, it is also difficult to obtain a film containing MXene and having sufficiently high oxidation resistance.

According to one aspect of the present disclosure, a two-dimensional particle-containing composition is provided, the composition comprising two-dimensional particles of a layered material comprising one or plural layers; and a dispersion medium having a relative permittivity greater than that of water.

The one or plural layers comprise a layer body represented by:

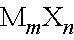

wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
n is not less than 1 and not more than 4, and
m is more than n but not more than 5, and

a modifier or terminal T (Tis at least one selected from a hydroxyl group, a fluorine atom, a chlorine atom, an oxygen atom, and a hydrogen atom) existing on a surface of the layer body, and
the two-dimensional particles have a fluorine element and an oxygen element.

According to another aspect of the present disclosure, a production method for a two-dimensional particle-containing composition is provided, the method comprising:
(a) preparing a precursor represented by:

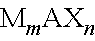

wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
A is at least one element of Group 12, 13, 14, 15, or 16,
n is not less than 1 and not more than 4, and
m is more than n but not more than 5;
(b) performing an etching treatment for removing at least some A atoms from the precursor and an intercalation treatment of a metal cation using an etching liquid containing a metal compound containing a metal cation and a fluoride to obtain a treated material;
(c) washing the treated material with water to obtain a water-washed material;
(d) mixing the water-washed material with a first dispersion medium having a relative permittivity greater than that of water and performing intercalation of the dispersion medium to obtain an intercalated material; and
(e) performing delamination in the presence of a second dispersion medium having a relative permittivity greater than that of water using the intercalated material.

According to the present disclosure, a metal element constituting one or plural layers included in two-dimensional particles (MXene particles) of a layered material in a MXene-containing composition is mainly formed of a metal element having a higher ionization energy than Ti, and the composition contains a dispersion medium having a relative permittivity greater than that of water. Thereby, a two-dimensional particle-containing composition having high dispersibility and high oxidation resistance is provided. Further, a production method capable of easily producing the two-dimensional particle-containing composition is provided.

### BRIEF DESCRIPTION OF THE DRAWINGS

FIGS. 1(a) and 1(b) are schematic cross-sectional views of MXene constituting two-dimensional particles of a layered material contained in a two-dimensional particle-containing composition of the present embodiment.

### DETAILED DESCRIPTION

### Embodiment 1: Two-Dimensional Particle-Containing Composition

Hereinafter, a two-dimensional particle-containing composition in one embodiment of the present disclosure will be described in detail, but the present disclosure is not limited to such an embodiment.

The two-dimensional particle-containing composition according to the present embodiment includes two-dimensional particles of a layered material comprising one or plural layers and a dispersion medium having a relative permittivity greater than that of water. The one or plural layers comprise a layer body represented by:

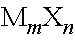

wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
n is not less than 1 and not more than 4, and
m is more than n but not more than 5, and
a modifier or terminal T (T is at least one selected from a hydroxyl group, a fluorine atom, a chlorine atom, an oxygen atom, and a hydrogen atom) existing on a surface of the layer body, and
the two-dimensional particles have a fluorine element and an oxygen element. The two-dimensional particle-containing composition exhibits high dispersibility and high oxidation resistance because the two-dimensional particle contains a metal element exhibiting a higher ionization energy than Ti and contains a dispersion medium having a relative permittivity greater than that of water.

The layered material can be understood as a layered compound and is also represented by “MₘXₙTₛ”, wherein s is any number, and conventionally x or z may be used in place of s. Typically, n can be 1, 2, 3, or 4, but is not limited thereto.

In the formula of MXene, M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M. In the present embodiment, it has been first found that in order to obtain a two-dimensional particle-containing composition having more excellent oxidation resistance, a metal element having a higher ionization energy than Ti accounts for half or more of the metal elements constituting the layered material. Examples of the at least one metal element M₁ of Group 3, 4, 5, 6, or 7 having a higher ionization energy than Ti include one or more metal elements selected from the group consisting of V, Nb, and Mo. One preferable form is that M is formed of at least one M₁ selected from the group consisting of V, Nb, and Mo.

Examples of the MXene according to the present embodiment include those in which the above formula: MₘXₙ is expressed as follows.
Sc₂C, Zr₂C, Zr₂N, Hf₂C, Hf₂N, V₂C, V₂N, Nb₂C, Ta₂C, Cr₂C, Cr₂N, Mo₂C, Mo_{1.3}C, (Ti, V)₂C, (Ti, Nb)₂C, W₂C, W_{1.3}C, Mo₂N, Nb_{1.3}C, Mo_{1.3} Y_{0.6}C (in the above formulae, “1.3” and “0.6” mean about 1.3 (=4/3) and about 0.6 (=2/3), respectively),
Zr₃C₂, (Ti, V)₃C₂, Hf₃C₂, (Hf₂V)C₂, (Hf₂Mn)C₂, (V₂Ti)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,
V₄C₃, Nb₄C₃, Ta₄C₃, (Ti, Nb)₄C₃, (Nb, Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃ (in the above formula, “2.7” and “1.3” mean about 2.7 (=8/3) and about 1.3 (=4/3), respectively).

The layer body of the two-dimensional particle is preferably one or more selected from the group consisting of V₂C, V₄C₃, and Mo₂Ti₂C₃.

When the layer body contains Ti as the metal element, it is preferable that the outermost M atom layer among a plurality of M atom layers constituting the layer body is a layer of a metal element other than Ti, and the inner M atom layer sandwiched with the outermost M atom layer is a metal element layer containing Ti.

In the present embodiment, MXene may contain remaining A atoms in a relatively small amount, for example, 10 mass % or less with respect to the original amount of A atoms. The remaining amount of A atoms can be preferably 8 mass % or less, and more preferably 6 mass % or less. However, even if the remaining amount of A atoms exceeds 10 mass %, there may be no problem depending on the use and conditions of use of the electrode.

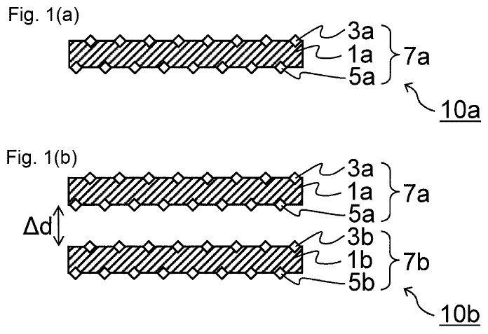

Hereinafter, the two-dimensional particles (also referred to as “MXene particles”) in the two-dimensional particle-containing composition according to the present embodiment will be described with reference to FIGS. 1(a) and 1(b).

The two-dimensional particle of the present embodiment is an aggregate including one layer of MXene 10a (single-layer MXene) schematically exemplified in FIG. 1(a). More specifically, MXene 10a is a MXene layer 7a having a layer body (MₘXₙ layer) 1a represented by MₘXₙ, and modifiers or terminals T 3a and 5a existing on the surface of the layer body 1a (more specifically, on at least one of two surfaces, facing each other, of each layer). Therefore, the MXene layer 7a is also represented by “MₘXₙTₛ,” wherein s is any number.

The particles of the layered material according to the present embodiment may include one layer as well as plural layers. Examples of the MXene (multilayer MXene) of plural layers include MXene 10b of two layers as schematically shown in FIG. 1(b), but are not limited thereto. 1b, 3b, 5b, and 7b in FIG. 1(b) are the same as 1a, 3a, 5a, and 7a in FIG. 1(a) described above. In the multilayer MXene, two adjacent MXene layers (for example, 7a and 7b) may not necessarily be completely separated from each other, but may be partially in contact with each other. The MXene 10a exists as one layer in which the multilayer MXene 10b is individually separated, and may be a mixture of the single-layer MXene 10a and the multilayer MXene 10b in which the unseparated multilayer MXene 10b remains. Even when the multilayer MXene is included, the multilayer MXene is preferably MXene having a small number of layers obtained through a delamination treatment. The expression “a small number of layers” means, for example, that the number of stacked layers of MXene is 10 or less. Hereinafter, the “multilayer MXene having a small number of layers” may be referred to as a “few-layer MXene”. The thickness of the few-layer MXene in the stacking direction is preferably 15 nm or less, and more preferably 10 nm or less. In addition, the single-layer MXene and the few-layer MXene may be collectively referred to as “single-layer/few-layer MXene”.

The particles of the layered material according to the present embodiment preferably contain a large amount of single-layer/few-layer MXene. When a large amount of single-layer/few-layer MXene is contained, the specific surface area of MXene can be made larger than that of the multilayer MXene, and as a result, for example, conductivity and the like can be enhanced. In the particles of the layered material according to the present embodiment, the number of stacked layers of MXene is 10 or less, the thickness is 15 nm or less, and preferably 10 nm or less, and the ratio of the single-layer/few-layer MXene to the total MXene is preferably 80 vol % or more, more preferably 90 vol % or more, and still more preferably 95 vol % or more. In addition, the volume of the single-layer MXene is more preferably larger than the volume of the few-layer MXene. Since the true density of these MXenes does not greatly vary depending on the existence form, it can be said that it is more preferable that the mass of the single-layer MXene is larger than the mass of the few-layer MXene. When these relationships are satisfied, the specific surface area can be further increased, and for example, the degradation over time of conductivity can be further suppressed. Most preferably, the particles of the layered material according to the present embodiment are formed only of the single-layer MXene.

Although not limiting the present embodiment, the thickness of each layer of MXene (which corresponds to the MXene layers 7a and 7b) is, for example, not less than 1 nm and not more than 30 μm, and may be, for example, not less than 1 nm and not more than 5 nm, and further not less than 1 nm and not more than 3 nm (which can vary mainly depending on the number of M atom layers included in each layer). In individual laminates of the multilayer MXene that may be included, the interlayer distance (alternatively, the void dimension, which is indicated by Δd in FIG. 1(b)) is, for example, not less than 0.8 nm and not more than 10 nm, particularly not less than 0.8 nm and not more than 5 nm, and more particularly about 1 nm, and the total number of layers may be not less than 2 and not more than 20,000.

### (Fluorine Element and Oxygen Element)

The two-dimensional particle has a fluorine element and an oxygen element on a surface thereof. Having a fluorine element and an oxygen element means that these elements are bonded and adsorbed to the surface of MXene, for example, in the form of an ion. When the two-dimensional particle has a fluorine element and an oxygen element each having a small atomic radius, for example, an oxygen element and a fluorine element each having a small atomic radius are present on the surface of the layer body constituting MXene, the interlayer distance is narrowed, the structure is stabilized to enhance the oxidation resistance, moisture absorption is suppressed due to insertion of water molecules between layers, and thus high moisture absorption resistance can be realized. The presence of a fluorine atom and an oxygen atom in the two-dimensional particle can be checked by an XPS method.

(One or More Selected from Group Consisting of Li Ion, Na Ion, and K Ion)

The two-dimensional particle preferably further contains one or more selected from the group consisting of a Li ion, a Na ion, and a K ion. These metal cations may be derived from a metal compound containing a metal cation used for intercalation of a metal cation in the process of producing the two-dimensional particle-containing composition. It is considered that when the compounds of these metal cations are used, for example, for intercalation in the production process, single layer formation easily proceeds, the structure of the two-dimensional particle is stabilized, and oxidation resistance is further improved.

The proportion (MXene content) of the two-dimensional particles contained in the two-dimensional particle-containing composition is not particularly limited. The MXene content in the composition can be, for example, 0.01 mass % or more in terms of solid content. The two-dimensional particles are hardly dispersed, and it has been conventionally difficult to form a composition. However, according to the two-dimensional particle-containing composition according to the present embodiment, since the two-dimensional particles are easily dispersed in a dispersion medium having a relative permittivity greater than that of water, a composition in which the two-dimensional particles have a high dispersion rate can be obtained. Use of this two-dimensional particle-containing composition having a high dispersion rate, for example, for film formation, enables production of a conductive film that requires a large thickness for, for example, electrode applications, with high productivity. For example, in order to form a thick film, the proportion of the two-dimensional particles in the two-dimensional particle-containing composition may be 1 mass % or more in terms of solid content. The proportion of the two-dimensional particles in the two-dimensional particle-containing composition may further be 1.5 mass % or more in terms of solid content. In consideration of the dispersibility of the two-dimensional particles, the upper limit of the proportion of the two-dimensional particles in the two-dimensional particle-containing composition is, for example, 10 mass % in terms of solid content.

### (Dispersion Medium)

Conventionally, TMAOH has been used for single layer formation in a MXene production process. However, TMAOH is likely to remain in MXene, leading to deterioration of properties including oxidation resistance. In addition, since TMAOH exhibits strong basicity, it is desired to produce MXene without using TMAOH from the viewpoint of work safety. In view of the above circumstances, extensive studies were made, and in the two-dimensional particle-containing composition according to the present embodiment, as a dispersion medium for dispersing the two-dimensional particles, a dispersion medium having a relative permittivity greater than that of water was determined to be used. In the dispersion medium having a relative permittivity greater than that of water, the charge of the two-dimensional particles (MXene particles) becomes more stable, so that the dispersibility is improved. Further, for high dispersion stability, it is possible to realize a two-dimensional particle-containing composition in which two-dimensional particles (MXene particles) are dispersed at a high content without aggregation. The relative permittivity of water is 80.4 at 20° C., and the dispersion medium for dispersing the two-dimensional particles need only be larger than the relative permittivity of water at 20° C. For example, a dispersion medium having a relative permittivity of more than 80, and moreover 100 or more can be used. Hereinafter, a dispersion medium having a relative permittivity greater than that of water may be referred to as a “high relative permittivity dispersion medium”. As a preferable aspect, the two-dimensional particle-containing composition of the present embodiment does not contain TMAOH that has been conventionally used.

Examples of the dispersion medium having a relative permittivity greater than that of water include N-methylformamide (NMF, relative permittivity: 171) and N-methylacetamide (NMAc, relative permittivity: 179), and one or more of these can be used.

In the present embodiment, a mixed dispersion medium of a high relative permittivity dispersion medium and another dispersion medium may be used as long as the relative permittivity is greater than that of water. Preferable examples of the dispersion medium include a dispersion medium containing at least one or more of N-methylformamide and N-methylacetamide which are high relative permittivity dispersion media. More preferably, the dispersion medium contains 50 vol % or more of at least one or more of N-methylformamide and N-methylacetamide. Examples of another dispersion medium include a dispersion medium having a relative permittivity of 10 or more, and examples thereof include an aqueous dispersion medium and an organic dispersion medium. The aqueous dispersion medium is typically water, and in some cases, an aqueous solution containing a relatively small amount (for example, 30 mass % or less, preferably 20 mass % or less with respect to the whole mass) of another liquid substance in addition to water can be mentioned. Examples of the organic dispersion medium include acetonitrile (relative permittivity: 38), N,N-dimethylacetamide (relative permittivity: 38), N,N-dimethylformamide (relative permittivity: 37), DMSO (relative permittivity: 47), DMF (relative permittivity: 37), NMP (relative permittivity: 32), acetone (relative permittivity: 20), and alcohols including 2-methyl-2-propanol (relative permittivity: 10), isopropyl alcohol (relative permittivity: 18), ethanol (relative permittivity: 25), and methanol (relative permittivity: 33). The dispersion medium having a relative permittivity greater than that of water preferably contains NMF having a high relative permittivity, and most preferably a dispersion medium formed of NMF.

### (Additive)

The two-dimensional particle-containing composition according to the present embodiment may contain an amine such as tetramethylammonium hydroxide, hexylamine, or octylamine, or an additive such as polyphosphoric acid or sodium ascorbate, in addition to the two-dimensional particles and the dispersion medium. The proportion of the additive in the composition is not particularly limited, but from the viewpoint of increasing the concentration of the two-dimensional particles, or the like, the proportion of the additive in the composition is reduced to, for example, 10 mass % or less.

### (Form of Composition)

Examples of the two-dimensional particle-containing composition according to the present embodiment include an ink, a paste, and a slurry.

As the paste, a conductive paste of a composite material containing a polymer is exemplified as one embodiment. The mass ratio of the two-dimensional particles (particles of the layered material) in the conductive paste is, for example, 50% or more. Examples of the polymer include hydrophilic polymers (including one exhibiting hydrophilicity by mixing a hydrophilic auxiliary agent in a hydrophobic polymer, and one obtained by hydrophilization treatment of a surface of a hydrophobic polymer or the like), and the hydrophilic polymer preferably includes one or more selected from the group consisting of polysulfone, cellulose acetate, regenerated cellulose, polyethersulfone, water-soluble polyurethane, polyvinyl alcohol, sodium alginate, an acrylic acid-based water-soluble polymer, polyacrylamide, polyaniline sulfonic acid, and nylon.

The hydrophilic polymer is more preferably a hydrophilic polymer having a polar group, in which the polar group is a group that forms a hydrogen bond with a modifier or terminal T of the layer. As the polymer, for example, one or more polymers selected from the group consisting of water-soluble polyurethane, polyvinyl alcohol, sodium alginate, an acrylic acid-based water-soluble polymer, polyacrylamide, polyaniline sulfonic acid, and nylon are more preferably used.

Among these, one or more polymers selected from the group consisting of water-soluble polyurethane, polyvinyl alcohol, and sodium alginate are further preferable. As the polymer, a polymer having a urethane bond having both a hydrogen bond donor property and a hydrogen bond acceptor property is preferable, and from this viewpoint, the water-soluble polyurethane is particularly preferable.

### Embodiment 2: Production Method for Two-Dimensional Particle-Containing Composition

Hereinafter, a production method for a two-dimensional particle-containing composition in an embodiment of the present disclosure will be described in detail, but the present disclosure is not limited to such an embodiment.

The production method for a two-dimensional particle-containing composition of the present embodiment includes:
(a) preparing a precursor represented by a formula below:

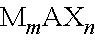

wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
A is at least one element of Group 12, 13, 14, 15, or 16,
n is not less than 1 and not more than 4, and
m is more than n but not more than 5;
(b) performing an etching treatment for removing at least some A atoms from the precursor and an intercalation treatment of a metal cation using an etching liquid containing a metal compound containing a metal cation and a fluoride to obtain a treated material;
(c) washing the treated material with water to obtain a water-washed material;
(d) mixing the water-washed material with a dispersion medium having a relative permittivity greater than that of water and performing intercalation of the dispersion medium to obtain an intercalated material; and
(e) performing delamination in the presence of a dispersion medium having a relative permittivity greater than that of water using the intercalated material. In the production method of the present embodiment, as described above, in the composition of MXene, the metal elements are configured such that the metal element having a higher ionization energy than Ti accounts for half or more, etching is performed with, for example, a fluoride-containing etching liquid, and further intercalation of a metal cation and mixing with a high relative permittivity dispersion medium are performed in the production process, and the like, whereby single layer formation sufficiently proceeds, and stabilization is sufficient due to having a fluorine element and an oxygen element, and as a result, a two-dimensional particle-containing composition having sufficiently excellent oxidation resistance can be obtained.

Hereinafter, each step of the production method will be described in detail.

### Step (a)

First, a predetermined precursor is prepared. The precursor usable in the present embodiment is a MAX phase that is a precursor of MXene, and is represented by a formula below:

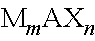

wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
A is at least one element of Group 12, 13, 14, 15, or 16,
n is not less than 1 and not more than 4, and
m is more than n but not more than 5.

The M, X, n, and m are as described for MXene. A is at least one element of Group 12, 13, 14, 15, or 16, normally an element of Group A, typically of Group IIIA and Group IVA, and more specifically can include at least one selected from the group consisting of Al, Ga, In, Tl, Si, Ge, Sn, Pb, P, As, S, and Cd, and is preferably Al.

The MAX phase has a crystal structure in which a layer formed of A atoms is located between two layers represented by MₘXₙ (may have a crystal lattice in which each X is located in the octahedral array of M). When typically m=n+1, but not limited thereto, the MAX phase includes repeating units in which each one layer of X atoms is disposed in between adjacent layers of n+1 layers of M atoms (these are also collectively referred to as “MₘXₙ layer”), and a layer of A atoms (“A atom layer”) is disposed as a layer next to the (n+1)th layer of M atoms.

The MAX phase can be produced by a known method. For example, VC powder, V powder, and Al powder are mixed in a ball mill, and the resulting mixed powder is fired under an Ar atmosphere to obtain a fired body (block-shaped MAX phase). Thereafter, the fired body obtained is pulverized by an end mill, so that a powdery MAX phase for the next step can be obtained.

### Step (b)

Etching (removal and optionally layer separation) of A atoms (and optionally some M atoms) from the precursor is performed and also an intercalation treatment of a metal cation is performed using an etching liquid containing a metal compound containing a metal cation and a fluoride.

The etching liquid contains a fluoride as described above. Examples of the fluoride include HF (hydrofluoric acid). The etching liquid preferably contains HF and one or more of H₃PO₄, HCl, HI, and H₂SO₄. For example, it is also possible to perform etching by a so-called MILD method in which HCl and LiF contained in an etching liquid are allowed to react in a system to generate HF, but it is preferable to perform etching by a so-called ACID method in which etching is performed with an etching liquid containing HF (hydrofluoric acid) as described above or with an etching liquid further containing phosphoric acid. These methods are preferable because according to these methods, as compared with the MILD method, particles (MXene particles) of a flaky layered material having a large planar region with a number average Feret diameter of preferably 3 μm or more can be easily obtained.

The etching liquid contains a metal compound containing a metal cation as described above. The reason why the etching liquid according to the present embodiment contains a metal compound containing a metal cation is as follows. That is, when the main constituent of the metal element M constituting the MAX phase is Ti, the MₘXₙ layer can be formed into a single layer by a method in which etching is performed and then an intercalation treatment is performed. However, as a result of a preliminary experiment conducted by the present inventors, in a case where the main constituent of the metal element M constituting the MAX phase was not Ti but was a metal element having an ionization energy higher than that of Ti, it was difficult to realize intercalation of a metal cation by a method in which an intercalation treatment is performed after etching. Therefore, as a result of studies by the present inventors, it was found that when an intercalation treatment of a metal cation in which a monovalent metal cation is inserted between layers of the MₘXₙ layer is performed together with etching (removal and optionally layer separation) of A atoms (and optionally some M atoms) from the MAX phase, intercalation of a metal cation can be realized even if the main constituent of the metal element M constituting the MAX phase is a metal element having a higher ionization energy than Ti.

Examples of the metal cation include one or more selected from the group consisting of a Li ion, a Na ion, and a K ion. The metal compound containing a metal cation contains at least one of a Li compound, a Na compound, or a K compound. Examples of the metal compound containing a metal cation include an ionic compound in which the metal cation and a cation are bonded, and for example, a chloride of the metal cation is exemplified. Preferable examples of the metal compound containing a metal cation include lithium chloride.

The content of the metal compound containing a metal cation in the etching liquid is preferably 0.001 mass % or more. The content is more preferably 0.01 mass % or more, still more preferably 0.1 mass % or more. On the other hand, from the viewpoint of dispersibility in the solution, the content of the metal compound containing a metal cation in the etching liquid is preferably 10 mass % or less.

Other conditions for etching are not particularly limited, and known conditions can be adopted. The etching liquid may contain, for example, pure water as a solvent. When HF is used as a fluoride, for example, the etching liquid may have a HF concentration of not less than 1.5 M and not more than 14 M. In addition, when one or more of H₃PO₄, HCl, HI, and H₂SO₄ are contained together with a fluoride (for example, HF), the H₃PO₄ concentration may be 5.5 M or more, the HCl concentration may be 6.0 M or more, the HI concentration may be 5.0 M or more, and the H₂SO₄ concentration may be 5.0 M or more. In the etching of the A atoms, some M atoms may be selectively etched together with the A atoms. Examples of the etched material obtained by the etching include a slurry.

### Step (c)

The treated material obtained by performing the etching treatment and the intercalation treatment is washed with water to obtain a water-washed material.

The amount of water to be mixed with the etched material and the cleaning method are not particularly limited. Examples thereof include a method in which water is added and stirring, centrifugation, and the like are performed. Examples of a stirring method include stirring using hand shaking, an automatic shaker, a shear mixer, a pot mill, or the like. The degree of stirring such as a stirring speed and a stirring time may be adjusted according to the amount, concentration, and the like of the object to be treated. The washing with water may be performed one or more times. Preferably, washing with water is performed multiple times. For example, specifically, steps (i) to (iv): (i) adding water (to the treated material or the remaining precipitate obtained in the following (iv)), (ii) stirring, (iii) centrifuging the stirred material, and (iv) discarding the supernatant after centrifugation, and collecting the remaining precipitate are performed two or more times, for example, within a range of 15 times or less.

### Step (d)

The water-washed material and a dispersion medium having a relative permittivity greater than that of water are mixed and intercalation of the dispersion medium is performed to obtain an intercalated material.

The ratio of the water-washed material and the dispersion medium can be a ratio (in the production scale, the solid contents of both the dispersion medium and the water-washed material are increased in this ratio) of the water-washed material of not less than 0.1 g and not more than 10 g in terms of solid content with respect to the dispersion medium of not less than 1 mL and not more than 100 mL. In this step, a mixture for stirring containing the water-washed material and the dispersion medium can be stirred at 20 to 25° C. (room temperature). Examples of the stirring method include a method using a stirring bar such as a stirrer, a method using a stirring blade, a method using a mixer, and a method using a centrifugal device. The stirring time can be set according to the production scale, and for example, it can be set to 10 to 24 hours.

### Step (e)

Delamination is performed in the presence of a dispersion medium having a relative permittivity greater than that of water using the intercalated material.

The delamination allows for the formation of a single layer and fewer layers of MXene. Examples of a stirring method include stirring using hand shaking, an automatic shaker, or the like. The degree of stirring such as a stirring speed and a stirring time may be adjusted according to the amount, concentration, and the like of a material to be treated. In the production method of the present embodiment, an ultrasonic treatment is not performed as delamination. As described above, since an ultrasonic treatment is not performed, particle destruction is unlikely to occur, and as a result, single-layer/few-layer MXene having a large plane parallel to the layer of particles, that is, a large two-dimensional plane, and a large number average Feret diameter can be obtained as the particles of the layered material.

The dispersion medium having a relative permittivity greater than that of water used for mixing is the same as the dispersion medium having a relative permittivity greater than that of water described in (Embodiment 1: Two-dimensional particle-containing composition) above.

The delamination may be performed by, for example, the following method. That is, the slurry after being mixed with the dispersion medium having a relative permittivity greater than that of water is centrifuged to recover the supernatant, thereafter, the dispersion medium having a relative permittivity greater than that of water is added to the supernatant, and then stirring is performed by, for example, hand shaking or an automatic shaker, then centrifugation is performed, and the supernatant is recovered, and this process is repeated. Subsequently, the collected supernatant is centrifuged, and then the generated supernatant is discarded to obtain clay-like single-layer/few-layer MXene as a delaminated material.

### Embodiment 3: Film Formed of Two-Dimensional Particle-Containing Composition

The present embodiment includes a film obtained using the two-dimensional particle-containing composition. The film formed of the two-dimensional particle-containing composition exhibits excellent oxidation resistance.

The method for forming the film according to the present embodiment is not limited, and examples thereof include filtration, coating, and immersion. Examples of the filtration method include suction filtration of the two-dimensional particle-containing composition. As a filter for suction filtration, for example, a membrane filter (Durapore, manufactured by Merck & Co., Inc., pore size: 0.45 μm) can be used. Examples of a coating method include spray coating in which spray coating is performed using a nozzle such as a one-fluid nozzle, a two-fluid nozzle, or an air brush, slit coating using a table coater, a comma coater, or a bar coater, screen printing, metal mask printing, spin coating, immersion, brush, and dropping.

The coating and drying may be repeated multiple times as necessary until a film having a desired thickness is obtained. Drying and curing can be performed, for example, at a temperature of not lower than 80° C. and not higher than 400° C. using a normal pressure oven or a vacuum oven.

The obtained film can be used as, for example, a conductive film. For example, it may be utilized in applications in which a high conductivity is required, such as an electrode or an electromagnetic shield (EMI shield) in any suitable electrical device. The electrode is not particularly limited, and may be, for example, a capacitor electrode, a battery electrode, a biosignal sensing electrode, a sensor electrode, an antenna electrode, or the like. Use of the film of the present embodiment can provide a large-capacity capacitor and battery, a low-impedance a biosignal sensing electrode, a highly sensitive sensor, and an antenna even with a smaller volume (device-occupied volume).

### EXAMPLES

Hereinafter, the present disclosure will be described more specifically with reference to examples. The present disclosure is not limited by the following examples, and can be implemented with appropriate modifications within the scope that can be consistent with the above- and below-mentioned gist, and all of them are included in the technical scope of the present disclosure.

### [Fabrication of Single-Layer MXene]

### Inventive Example 1

In Inventive Example 1, a two-dimensional particle-containing composition (MXene-containing composition) was fabricated by sequentially performing (1) preparation of a precursor (MAX), (2) etching of the precursor and Li intercalation, (3) water washing, (4) intercalation of a high relative permittivity dispersion medium (N-methylformamide), and (5) delamination described in detail below.

### (1) Preparation of Precursor (MAX)

VC powder, V powder, and Al powder (all manufactured by Kojundo Chemical Laboratory Co., Ltd.) were placed in a ball mill containing zirconia balls at a molar ratio of 3:1:1 and mixed for 24 hours. The obtained mixed powder was fired in an Ar atmosphere at 1600° C. for 2 hours. The fired body (block-shaped MAX) thus obtained was crushed with an end mill to a maximum size of 40 μm or less. In this way, V₄AlC₃ particles were obtained as the precursor (powdery MAX).

### (2) Etching of Precursor and Li Intercalation

Etching was performed under the following etching conditions using the V₄AlC₃ particles (powder) prepared by the above method to obtain a solid-liquid mixture (slurry) containing a solid component derived from the V₄AlC₃ powder.

### (Etching Conditions)

Precursor: V₄AlC₃ (Sieving with 45 μm mesh)
Etching liquid formulation: 49% HF 60 mL
Metal salt: LiCl 3 g
Precursor charge amount: 3.0 g
Reaction vessel: 100 mL Eye Boy
Etching temperature: 50° C.
Etching time: 48 h
Stirrer rotation speed: 400 rpm

### (3) Water Washing

The slurry was equally divided into two portions and inserted into two 50 mL centrifuge tubes. Then, centrifugation was performed under conditions of 3500 G and 5 minutes using a centrifuge, and then the supernatant was discarded. Thereafter, (i) 35 mL of pure water was added to the remaining precipitate in each centrifuge tube, (ii) the mixture was stirred by hand shaking, (iii) the mixture was centrifuged under conditions of 3500 G and 5 minutes, and (iv) the supernatant was removed. The steps (i) to (iv) were repeated 11 times in total. Finally, centrifugation was performed under conditions of 3500 G and 5 minutes using a centrifuge, and then the supernatant was discarded to obtain a V₄C₃Tₛ-water medium clay.

(4) Intercalation of Dispersion Medium by Mixing with High Relative Permittivity Dispersion Medium (N-Methylformamide)

The V₄C₃Tₛ-water medium clay prepared by the above method and N-methylformamide (NMF) as the high relative permittivity dispersion medium were mixed under the following conditions to perform intercalation of NMF.

(Mixing Condition with High Relative Permittivity Dispersion Medium (N-Methylformamide))
V₄C₃Tₛ-water medium clay (MXene after washing): Solid content: 0.5 g
Dispersion medium: NMF 20 mL
Reaction vessel: 100 mL Eye Boy
Temperature: 20 to 25° C. (Room temperature)
Stirring time: 11 h
Stirring rotation speed: 700 rpm

### (5) Delamination

The slurry obtained by mixing with the NMF was transferred to a 50 mL centrifuge tube, 20 mL of the NMF was added, and then centrifugation was performed under conditions of 3500 G and 5 min using a centrifuge, and then the supernatant was recovered. Thereafter, (i) 35 mL of NMF was added to the supernatant, (ii) the mixture was stirred for 15 minutes by a shaker, (iii) the mixture was centrifuged under conditions of 3500 G and 5 minutes, and (iv) the supernatant containing MXene formed into a single layer was recovered. The steps (i) to (iv) were repeated four times in total to recover all the supernatant. Thereafter, the obtained supernatant was centrifuged under the conditions of 4300 G for 2 hours using a centrifuge to precipitate MXene, and the supernatant was discarded. Then, the precipitate was obtained as the two-dimensional particle-containing composition.

### Inventive Example 2

In Inventive Example 2, a two-dimensional particle-containing composition was obtained in the same manner as in Inventive Example 1 except that the (1) preparation of a precursor (MAX) and the (2) etching of the precursor and Li intercalation were performed as follows.

### (1) Preparation of Precursor (MAX)

Nb powder, Al powder, and C powder (all manufactured by Kojundo Chemical Laboratory Co., Ltd.) were placed in a ball mill containing zirconia balls at a molar ratio of 2:1:1 and mixed for 24 hours. The obtained mixed powder was fired in an Ar atmosphere at 1550° C. for 2 hours. The fired body (block-shaped MAX) thus obtained was crushed with an end mill to a maximum size of 40 μm or less. In this way, Nb₂AlC particles were obtained as the precursor (powdery MAX).

### (2) Etching of Precursor and Li Intercalation

Etching was performed under the following etching conditions using the Nb₂AlC particles (powder) prepared by the above method to obtain a solid-liquid mixture (slurry) containing a solid component derived from the Nb₂AlC powder.

### (Etching Conditions)

Precursor: Nb₂AIC (Sieving with 45 μm mesh)
Etching liquid formulation: 49% HF 36 mL+36% HCl 24 ml
Metal salt: LiCl 3 g
Precursor charge amount: 3.0 g
Reaction vessel: 100 mL Eye Boy
Etching temperature: 35° C.
Etching time: 48 h
Stirrer rotation speed: 400 rpm

### Inventive Example 3

In Inventive Example 3, a two-dimensional particle-containing composition was obtained in the same manner as in Inventive Example 1 except that the (1) preparation of a precursor (MAX) and the (2) etching of the precursor and Li intercalation were performed as follows.

### (1) Preparation of Precursor (MAX)

Mo powder, Ti powder, Al powder, and C powder (all manufactured by Kojundo Chemical Laboratory Co., Ltd.) were placed in a ball mill containing zirconia balls at a molar ratio of 2:2:1:3 and mixed for 24 hours. The obtained mixed powder was fired in an Ar atmosphere at 1600° C. for 2 hours. The fired body (block-shaped MAX) thus obtained was crushed with an end mill to a maximum size of 40 μm or less. In this way, Mo₂Ti₂AlC₃ particles were obtained as the precursor (powdery MAX).

### (2) Etching of Precursor and Li Intercalation

Etching was performed under the following etching conditions using the Mo₂Ti₂AlC₃ particles (powder) prepared by the above method to obtain a solid-liquid mixture (slurry) containing a solid component derived from the Mo₂Ti₂AlC₃ powder.

### (Etching Conditions)

Precursor: Mo₂Ti₂AlC₃ (Sieving with 45 μm mesh)
Etching liquid formulation: 49% HF 60 mL
Metal salt: LiCl 3 g
Precursor charge amount: 3.0 g
Reaction vessel: 100 mL Eye Boy
Etching temperature: 50° C.
Etching time: 48 h
Stirrer rotation speed: 400 rpm

### Inventive Example 4

In Inventive Example 4, a two-dimensional particle-containing composition was obtained in the same manner as in Inventive Example 1 except that the (1) preparation of a precursor (MAX) and the (2) etching of the precursor and Li intercalation were performed as follows.

### (1) Preparation of Precursor (MAX)

VC powder, V powder, and Al powder (all manufactured by Kojundo Chemical Laboratory Co., Ltd.) were placed in a ball mill containing zirconia balls at a molar ratio of 1:1:1 and mixed for 24 hours. The obtained mixed powder was fired in an Ar atmosphere at 1550° C. for 2 hours. The fired body (block-shaped MAX) thus obtained was crushed with an end mill to a maximum size of 40 μm or less. In this way, V₂AIC particles were obtained as the precursor (powdery MAX).

### (2) ETCHING OF PRECURSOR AND Li INTERCALATION

Etching was performed under the following etching conditions using the V₂AIC particles (powder) prepared by the above method to obtain a solid-liquid mixture (slurry) containing a solid component derived from the V₂AIC powder.

### (Etching Conditions)

Precursor: V₂AIC (Sieving with 45 μm mesh)
Etching liquid formulation: 49% HF 36 mL+36% HCl 24 mL
Metal salt: LiCl 3 g
Precursor charge amount: 3.0 g
Reaction vessel: 100 mL Eye Boy
Etching temperature: 35° C.
Etching time: 48 h
Stirrer rotation speed: 400 rpm

### Comparative Examples 1 and 2

Compositions were obtained in the same manner as in Inventive Example 1 except that in Comparative Example 1, Ti powder, Al powder, and C powder (all manufactured by Kojundo Chemical Laboratory Co., Ltd.) were mixed at a molar ratio of 2:1:1 in the (1) preparation of a precursor (MAX), in Comparative Example 2, TiC powder, Ti powder, and Al powder (all manufactured by Kojundo Chemical Laboratory Co., Ltd.) were mixed at a molar ratio of 2:1:1 in the (1) preparation of a precursor (MAX), and in Comparative Examples 1 and 2, the (4) intercalation of a high relative permittivity dispersion medium (N-methylformamide) was not performed, and the (5) delamination was performed with pure water in place of NMF.

### Comparative Examples 3 to 5

In Comparative Examples 3 to 5, compositions were obtained in the same manner as in Inventive Examples 4, 2, and 3, respectively, except that both the (4) intercalation of a high relative permittivity dispersion medium (N-methylformamide) and the (5) delamination were performed using TMAOH in place of NMF.

### Comparative Example 6

In Comparative Example 6, a composition was obtained in the same manner as in Comparative Example 3 except that both the (4) intercalation of a high relative permittivity dispersion medium (N-methylformamide) and the (5) delamination were not performed.

Note that Comparative Examples 1 to 6 correspond to examples shown in Non-patent Document 1.

### [Evaluation]

Dispersibility and oxidation resistance were evaluated using the compositions obtained in Inventive Examples 1 to 4 and Comparative Examples 1 to 6. Details of each evaluation method will be described below. In Inventive Examples 1 to 4, since etching was performed using an HF aqueous solution, it is presumed that oxygen atoms and fluorine atoms are present as surface groups of MXene particles.

In the present example, since LiCl was used as the metal compound containing a metal cation in the process for producing the two-dimensional particle-containing composition, the obtained two-dimensional particle-containing composition is considered to contain Li ions.

### 1. Dispersibility

Centrifugation of 40 mL of a 0.01 mass % solution of MXene was performed using a centrifuge under the conditions of 3500 G and 1 min. Then, after removing the supernatant, the weight of the precipitate was measured and evaluated as follows.

### (Evaluation Criteria for Dispersibility)

The amount of the precipitate is 30 mass % or less of the total amount of the solution: A

The amount of the precipitate is more than 30 mass % but less than 80 mass % of the total amount of the solution: B

The amount of the precipitate is 80 mass % or more of the total amount of the solution: C

### 2. Oxidation Resistance

As described in detail below, the oxidation resistance was evaluated by preparing a dispersion solution of MXene, performing an acceleration test, and then measuring the absorbance at a predetermined wavelength.

### (Liquid Preparation)

MXene was diluted with ultrapure water to prepare a dispersion solution having a concentration of MXene of 1×10⁻⁴ mg/mL. Then, liquid preparation was performed so that the absorbance reading in the calibration curve at each of the following wavelengths falls within the range of 0.4 to 0.5:
a wavelength at which MXene with M being V-based (V: 50 atom % or more) has a plasmon resonance peak: 900 nm;
a wavelength at which MXene with M being Nb-based (Nb: 50 atom % or more) has a plasmon resonance peak: 880 nm;
a wavelength at which MXene with M being Mo-based (Mo: 50 atom % or more) has a plasmon resonance peak: 500 nm; and
a wavelength at which MXene other than the above has a plasmon resonance peak:

780 nm. In order to ensure dispersibility after the liquid preparation, a treatment was performed in an ultrasonic bath at 28 kHz for 10 seconds.

### (Acceleration Test)

An acceleration test was performed while stirring in a heated water bath. Specifically, 40 mL of the dispersion solution of MXene was heated for 7 days at a water bath set temperature of 60° C. (actual temperature: 50° C.) under a stirring condition of 500 rpm.

### (Absorbance Measurement)

The absorbance of the dispersion solution before the acceleration test and the absorbance of the dispersion solution after heating for 7 days were measured. ASV-11D-H (manufactured by AS ONE Corporation) was used as a measuring instrument. In addition, as described above, the measurement wavelength was set to a wavelength at which each MXene has a plasmon resonance peak, that is, 900 nm in the case of MXene with M being V-based (V: 50 atom % or more), 880 nm in the case of MXene with M being Nb-based (Nb: 50 atom % or more), 500 nm in the case of MXene with M being Mo-based (Mo: 50 atom % or more), and 780 nm in the case of other MXenes. The absorbance of the dispersion solution before the acceleration test was taken as 100%, and the ratio (%) of the obtained absorbance to the absorbance of the dispersion solution before the acceleration test was determined. The higher the ratio (%), the smaller the degree of oxidation and the better the oxidation resistance.

In the present example, evaluation was performed according to the following evaluation criteria using the ratio (%) of the obtained absorbance to the absorbance of the dispersion solution before the acceleration test. That is, a case where the ratio to the absorbance of the dispersion solution before the acceleration test is more than 70% was rated as excellent in oxidation resistance (evaluation: A). The ratio to the absorbance of the dispersion solution before the acceleration test is preferably 73% or more, more preferably 77% or more. The ratio to the absorbance of the dispersion solution before the acceleration test of Inventive Example 1, which was evaluated as A, was 77%, the ratio of Inventive Example 2 was 80%, the ratio of Inventive Example 3 was 73%, and the ratio of Inventive Example 4 was 76%.

### (Evaluation Criteria for Oxidation Resistance)

The ratio to the absorbance of the dispersion solution before the acceleration test is more than 70%: A

The ratio to the absorbance of the dispersion solution before the acceleration test is more than 50% but not more than 70%: B

The ratio to the absorbance of the dispersion solution before the acceleration test is 50% or less: C

The evaluation results of the dispersibility and oxidation resistance are shown in Table 1.

TABLE 1

| | | | | Evaluation (2) Oxidation resistance | |
|---|---|---|---|---|---|
| | Formulation | Other | Evaluation (1) | Ratio to absorbance of dispersion | |
| Sample | of Mxene | Inclusions | Dispersibility | solution before acceleration test | |
| Comparative | Ti2CTx | Li ion | A | 10% | C |
| Example 1 * | | | | | |
| Comparative | Ti3C2Tx | Li ion | A | 70% | B |
| Example 2 * | | | | | |
| Comparative | V2CTx | TMAOH | B | 40% | C |
| Example 3 * | | | | | |
| Comparative | Nb2CTx | TMAOH | A | 50% | C |
| Example 4 * | | | | | |
| Comparative | Mo2Ti2C3Tx | TMAOH | A | 40% | C |
| Example 5 * | | | | | |
| Comparative | V2CTx | — | C | Not evaluable | |
| Example 6 * | (multilayer) | | | | |
| Inventive | V4C3Tx | NMF + Li ion | A | 77% | A |
| Example 1 | | | | | |
| Inventive | Nb2CTx | NMF + Li ion | A | 80% | A |
| Example 2 | | | | | |
| Inventive | Mo2Ti2C3Tx | NMF + Li ion | A | 73% | A |
| Example 3 | | | | | |
| Inventive | V2CTx | NMF + Li ion | A | 76% | A |
| Example 4 | | | | | |

* Corresponding to example described in Non-patent Document 1

The following can be seen from Table 1. That is, in Comparative Example 1 and Comparative Example 2, the formulation of MXene was outside the specification of the present embodiment, and the obtained two-dimensional particle-containing composition was poor in oxidation resistance. In Comparative Examples 3 to 5, the formulation of MXene was within the specification, but the dispersion medium contained was TMAOH, and all of them were considerably poor in oxidation resistance. In Comparative Example 6, intercalation of Li or the like and delamination were not performed, and the MXene is multilayer MXene, and therefore the dispersibility was considerably low, and oxidation resistance could not be evaluated. On the other hand, the two-dimensional particle-containing compositions of Inventive Examples 1 to 4 had high dispersibility and exhibited excellent oxidation resistance because the formulation of MXene was within the specification, and a dispersion medium having a relative permittivity greater than that of water was contained.

The two-dimensional particle-containing composition of the present disclosure is excellent in dispersibility and also excellent in oxidation resistance. The film formed using this two-dimensional particle-containing composition can be used for any appropriate application, and for example, can be preferably used as an electromagnetic shield (EMI shield), an electrode such as a capacitor electrode, a battery electrode, a biosignal sensing electrode, a sensor electrode, or an antenna electrode, or the like.

### REFERENCE SIGNS LIST

1a, 1b: Layer body (MₘXₙ layer)
3a, 5a, 3b, 5b: Modifier or terminal T
7a, 7b: MXene layer
10, 10a, 10b: Particles of layered material

1. A two-dimensional particle-containing composition, the composition comprising
two-dimensional particles of a layered material comprising one or plural layers, wherein the one or plural layers comprise a layer body represented by: 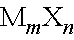
wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
n is not less than 1 and not more than 4, and
m is more than n but not more than 5, and
a modifier or terminal T existing on a surface of the layer body, wherein Tis at least one selected from a hydroxyl group, a fluorine atom, a chlorine atom, an oxygen atom, and a hydrogen atom, and
the two-dimensional particles have a fluorine element and an oxygen element; and
a dispersion medium having a relative permittivity greater than that of water.

2. The two-dimensional particle-containing composition according to claim 1, wherein M₁ is one or more metal elements selected from V, Nb, and Mo.

3. The two-dimensional particle-containing composition according to claim 1, wherein the two-dimensional particles further comprise one or more selected from a Li ion, a Na ion, and a K ion.

4. The two-dimensional particle-containing composition according to claim 1, wherein a content of the two-dimensional particles in the composition is 0.01 mass % or more in terms of solid content.

5. The two-dimensional particle-containing composition according to claim 1, wherein the content of the two-dimensional particles in the composition is 0.01 mass % to 10 mass % in terms of solid content.

6. The two-dimensional particle-containing composition according to claim 1, wherein the dispersion medium contains at least one or more of N-methylformamide and N-methylacetamide.

7. The two-dimensional particle-containing composition according to claim 1, wherein the dispersion medium contains 50 vol % or more of at least one or more of N-methylformamide and N-methylacetamide.

8. The two-dimensional particle-containing composition according to claim 1, wherein the layer body of the two-dimensional particles is one or more selected from V₂C, V₄C₃, and Mo₂Ti₂C₃.

9. The two-dimensional particle-containing composition according to claim 1, further comprising a polymer.

10. The two-dimensional particle-containing composition according to claim 9, wherein a mass ratio of the two-dimensional particles in the composition is 50% or more.

11. A film formed of the two-dimensional particle-containing composition according to claim 1.

12. A production method for a two-dimensional particle-containing composition, the method comprising:
(a) preparing a precursor represented by: 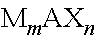
wherein M is
at least one metal element M₁ of Group 3, 4, 5, 6, or 7 having a higher ionization energy than Ti, or
a combination of the metal element M₁ that accounts for 50 atom % or more of M and a metal element M₂ of Group 3, 4, 5, 6, or 7 other than the metal element M₁ that accounts for 50 atom % or less of M,
X is a carbon atom, a nitrogen atom, or a combination thereof,
A is at least one element of Group 12, 13, 14, 15, or 16,
n is not less than 1 and not more than 4, and
m is more than n but not more than 5;
(b) performing an etching treatment for removing at least some A atoms from the precursor and an intercalation treatment of a metal cation using an etching liquid containing a metal compound containing a metal cation and a fluoride to obtain a treated material;
(c) washing the treated material with water to obtain a water-washed material;
(d) mixing the water-washed material with a first dispersion medium having a relative permittivity greater than that of water and performing intercalation of the dispersion medium to obtain an intercalated material; and
(e) performing delamination in the presence of a second dispersion medium having a relative permittivity greater than that of water using the intercalated material.

13. The production method for a two-dimensional particle-containing composition according to claim 12, wherein the first dispersion medium and the second dispersion medium are a same material.

14. The production method for a two-dimensional particle-containing composition according to claim 12, wherein the metal compound containing a metal cation contains at least one of a Li compound, a Na compound, or a K compound.

15. The production method for a two-dimensional particle-containing composition according to claim 12, wherein M₁ is one or more metal elements selected from V, Nb, and Mo.

16. The production method for a two-dimensional particle-containing composition according to claim 12, wherein at least one of the first dispersion medium and the second dispersion medium contains at least one or more of N-methylformamide and N-methylacetamide.

17. The production method for a two-dimensional particle-containing composition according to claim 12, wherein at least one of the first dispersion medium and the second dispersion medium contains 50 vol % or more of at least one or more of N-methylformamide and N-methylacetamide.
